(19) United States
(12) Patent Application Publication
(10) Pub. No.: US 2026/0092630 A1
(43) Pub. Date: Apr. 2, 2026

(54) PRINTED BRAKE WEAR SENSORS

(71) Applicant: Ford Global Technologies, LLC, Dearborn, MI (US)

(72) Inventors: Keith WESTON, Canton, MI (US); Dave D. FRISKE, Wolverine Lake, MI (US); Rob EATON, Bloomfield, MI (US)

(21) Appl. No.: 18/901,656

(22) Filed: Sep. 30, 2024

(51) Int. Cl. F16D 66/02; B41J 3/407; F16D 66/00

(52) U.S. Cl. CPC F16D 66/027; B41J 3/407; F16D 2066/001

(57) ABSTRACT

A brake pad may include a brake lining configured to engage with a brake rotor operably coupled to a wheel of the vehicle to apply friction to slow the vehicle, a backing plate to provide support to the brake lining, and a wear indicating circuit operably coupled to the brake lining to detect brake lining wear. The wear indicating circuit may be externally printed on the brake pad via conductive ink.

### TECHNICAL FIELD

Example embodiments generally relate to wheel assembly components and, more particularly, relate to a brake pad for increased brake wear detection.

### BACKGROUND

Brake pads are essential to brake system performance and general vehicle performance. As such, detecting and properly indicating brake pad wear values is an important part of monitoring brake system performance, and accordingly, vehicle performance.

Often, mechanical brake wear sensors perform standard wear detection and indication in brake pads via emitting noise responsive to brake wear. Furthermore, mechanical brake wear sensors and even electrical brake wear sensors often need to be embedded within and/or alter the physical construction of the brake pad to sense and communicate brake wear. Therefore, there is a need for an electronic brake wear sensor that detects and indicates brake pad wear, while not altering brake pad constructions or design.

### BRIEF SUMMARY OF SOME EXAMPLES

In accordance with an example embodiment, a brake pad for a brake system of a vehicle may be provided. The brake pad may include a brake lining configured to engage with a brake rotor operably coupled to a wheel of the vehicle to apply friction to slow the vehicle, a backing plate to provide support to the brake lining, and a wear indicating circuit operably coupled to the brake lining to detect brake lining wear. The wear indicating circuit may be externally printed on or within the brake pad via conductive ink.

In another example embodiment, a brake system for a vehicle of an example embodiment may be provided. The brake system may include a brake rotor operably coupled to a wheel of the vehicle, and a brake pad to engage with the brake rotor to slow the vehicle. The brake pad may include a brake lining to engage with the brake rotor to apply friction to slow the vehicle, a backing plate to provide support to the brake lining, and a wear indicating circuit operably coupled to brake lining to detect brake lining wear. The wear indicating circuit may be externally printed on the brake pad via conductive ink.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 depicts a block diagram of a brake system for a vehicle in accordance with an example embodiment;

FIG. 2 illustrates a perspective view of a brake pad of a brake system in accordance with an example embodiment;

FIG. 3 depicts a perspective view of a brake pad of a brake system in accordance with an example embodiment;

FIG. 4 illustrates a perspective view of a brake pad of a brake system in accordance with an example embodiment;

FIG. 5 depicts a perspective view of a brake pad of a brake system in accordance with an example embodiment;

FIG. 6 illustrates a perspective view of a brake system in accordance with an example embodiment;

FIG. 7 depicts a perspective view of a brake system in accordance with an example embodiment; and

FIG. 8 illustrates a printing assembly for a brake pad in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Additionally, as used herein, terminology such as “about,” “approximately” and “substantially,” when used to refer to variability of parameters, should be understood to be definite approximations that account for variations in measurements that cannot be, or as one of skill in the art would appreciate, normally are not, measured precisely. Thus, for example, a parameter that is “about,” “approximately” or “substantially” a given value or a given characteristic should be understood to be sufficiently close to the given value or given characteristic such that performance of the object or product to which the parameter applies, from the perspective of one with ordinary skill in the art, is the same as though the object or product had precisely the given value or characteristic.

Some example embodiments described herein may address the issues described above. In this regard, for example, some embodiments may provide a brake pad with an added wear indicating circuit that does not change the design or structure of the brake pad. Some embodiments may provide for the wear indicating circuit to be applied via additive manufacturing to a complete brake pad. As a result, installation of the wear indicating circuit for the brake pad may require less effort, less invasive construction, less time and thus may be more efficient.

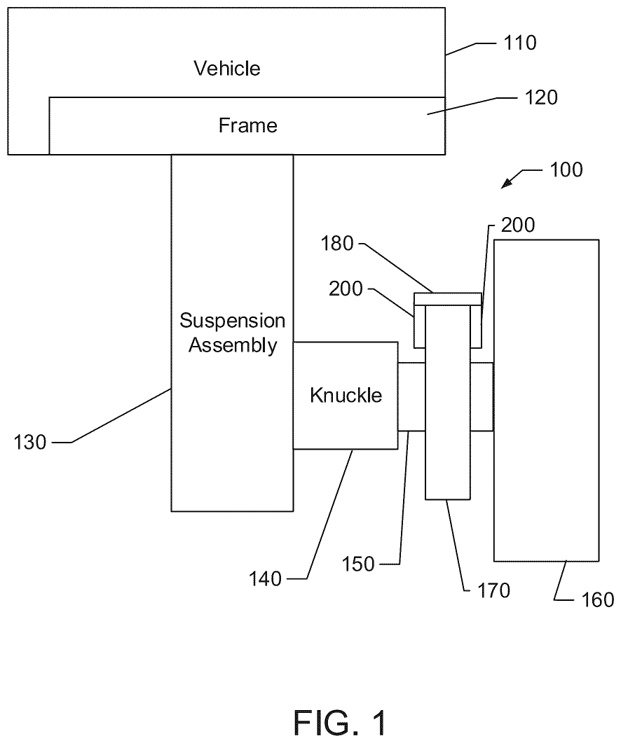

FIG. 1 illustrates a block diagram of a brake system 100 for a vehicle 110 in accordance with an example embodiment. As seen in FIG. 1, in some embodiments, the vehicle 110 may include a chassis or frame 120. The chassis or frame 120 may support and may form the foundation structure of the vehicle 110. In an example embodiment, the chassis and frame 120 may be formed of one or more casted or welded metal subframes or may be an unibody construction.

In some cases, the frame 120 may be operably coupled to a suspension assembly 130, and the suspension assembly 130 may be operably coupled to one or more wheel assemblies 160. The suspension assembly 130 may include a suspension damper or other suspension elements. The suspension assembly 130 may include multiple suspension dampers depending on the vehicle 110. The suspension damper may function to absorb compression and rebound loading along a longitudinal axis of the suspension damper. In this regard, the suspension damper may significantly limit oscillations and vibrations of the vehicle 110 by dampening the articulation motion of the one or more wheel assemblies 160 so that the articulation of the one or more wheel assemblies 160 is not directly transferred to the frame 120 of the vehicle 110.

The suspension assembly 130 may operably couple to the one or more wheel assemblies 160 via a knuckle 140 of the vehicle 110. The knuckle 140 may further be operably coupled to a wheel hub 150. The wheel hub 150 may directly operably couple with the one or more wheel assemblies 160 to connect the one or more wheel assemblies 160 to the suspension assembly 130. The wheel hub 150 may include fasteners to operably couple with a wheel rim of the one or more wheel assemblies 160.

In an example embodiment, the brake system 100 may operably couple to the wheel hub 150. The brake system 100 may include a brake rotor 170, a brake caliper 180, and a brake pad 200. In some cases, the brake pad 200 may include multiple brake pads, although a single brake pad 200 is also possible. The brake system 100 may help slow, stop and/or hold the vehicle 110 upon actuation of a brake pedal or receiving a brake trigger of the vehicle 110. The brake trigger may be a signal (e.g., electrical, hydraulic and/or the like) from a vehicle control system of the vehicle 110 that indicates the vehicle 110 is intended to initiate braking. The brake system 100 may apply negative torque to the vehicle 110 via the brake pad 200 applying friction to the brake rotor 170. If the brake system 100 has two instances of the brake pad 200, each brake pad 200 may engage an opposite side of the brake rotor 170 to help slow the vehicle 110.

The brake pad 200 may be operably coupled to the brake caliper 180. The brake caliper 180 may also serve to operably couple two brake pads to one another. Upon actuation of the brake pedal or receiving the brake trigger, the brake caliper 180 may push the brake pad 200 against the brake rotor 170. In some cases, the brake caliper 180 may include pistons that are the driving mechanism for pushing the brake pad 200 against the brake rotor 170. The pistons may be powered via hydraulic fluid provided via a brake hose or line. The brake caliper 180 may be electrically powered in some embodiments.

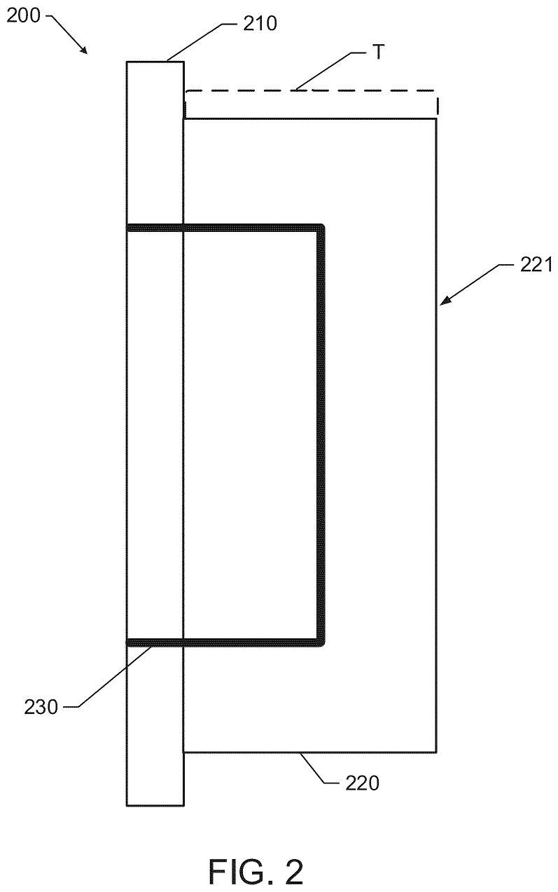

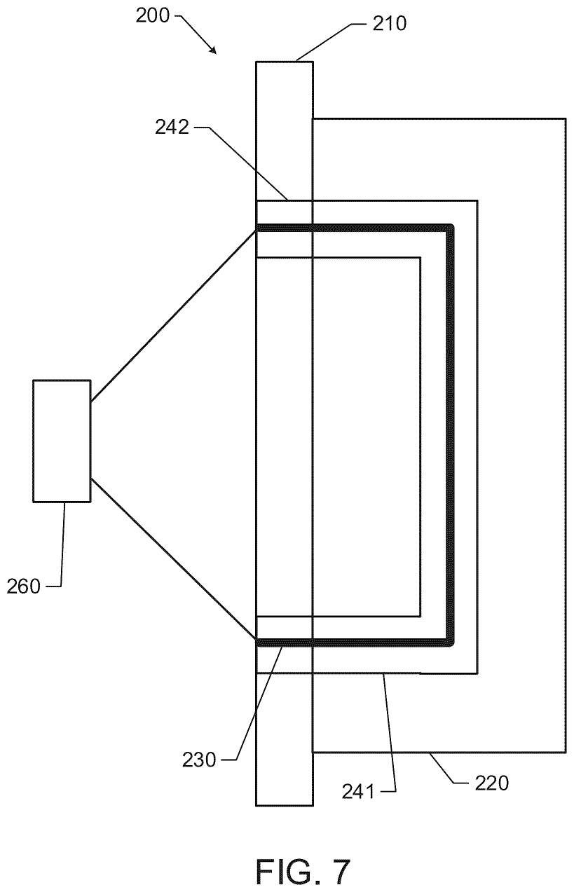

FIGS. 2-7 illustrate a brake pad and brake system according to example embodiments and primarily depict a side view of the brake pad and brake system according to example embodiments. The brake pad 200 may include a backing plate 210 and a brake lining 220. The backing plate 210 may provide support for the brake lining 220. The backing plate 210 may be operably coupled to the brake caliper 180, and the brake caliper 180 may push the backing plate 210 to apply force to the brake pad 200. The backing plate 210 may be comprised of a metal or other sturdy material that may properly support the brake lining 220.

The brake lining 220 may be comprised of a friction material, and the brake lining 220 may be affixed to the backing plate 210 via an adhesive or other coupling means. The brake lining 220 may selectively engage with the brake rotor 170 to apply friction to slow the vehicle 110 when the brake pedal is actuated or the brake system 100 is otherwise actuated. In some cases, the engagement of the brake lining 220 and the brake rotor 170 may be responsive to the force applied to the backing plate 210 by the brake caliper 180. The friction material of the brake lining 220 may be a ceramic, carbon composite, fiber-based material, semi-metallic material, or any number of materials that provide the desired level of friction to the brake rotor 170, as well as maintain the durability of the brake lining 220. In an example embodiment, the brake lining 220 may have a smaller length and width compared to the backing plate 210. In some cases, the thickness T of the brake lining 220 may be larger than the thickness of the backing plate 210.

The brake pad 200 may also include a wear indicating circuit 230. The wear indicating circuit 230 may help identify the amount of wear and the expected performance time of the brake pad 200. The wear indicating circuit 230 may be an electrical circuit extending along the brake pad 200. The wear indicating circuit 230 may be disposed on or within the brake lining 220 to detect wear of the friction material of the brake lining 220. A portion of the wear indicating circuit 230 may be substantially parallel with an exterior edge 221 the brake lining 220 that is closest to the brake rotor 170. Substantially parallel may be +/−5 degrees from parallel. In some cases, the arrangement of the wear indicating circuit 230 parallel to the exterior edge 221 may ensure that a consistent measuring or sensing capability may be provided along a majority of a length (i.e., a dimension perpendicular to the thickness T) of the brake lining 220 (and the exterior edge 221). Thus, for example, if the brake lining 220 wears more at one portion of the length of the exterior edge 221 than at another, the operator may be informed of the wear condition more quickly than if the wear indicating circuit 230 happened to be more localized at one portion of the brake lining 220 and the localized portion happened to not be the place where the wear was occurring faster.

Responsive to the brake lining experiencing wear, the wear indicating circuit 230 may be disrupted, interrupted or broken to open the circuit. Thus, for example, the wear indicating circuit 230 may be a closed circuit until the brake lining experiences enough wear so that the wear indicating circuit 230 itself begins to wear and is ultimately worn to the point that the closed circuit opens. Responsive to the wear indicating circuit 230 being open, a specific level of brake pad wear (i.e., to the depth from the exterior edge 221 to the location of the break in the wear indicating circuit 230) may be determined.

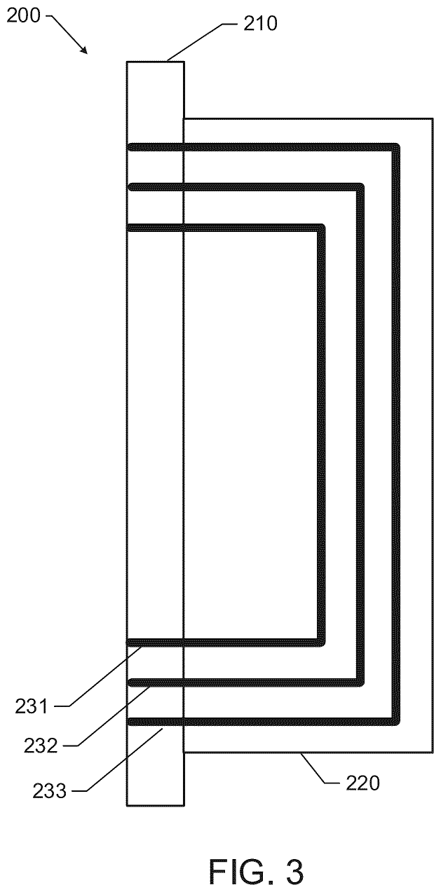

The wear indicating circuit 230 may be disposed at a specific thickness or percentage of the brake lining 220. For example, the wear indicating circuit 230 may be disposed at 50% of the thickness T of the brake lining 220. In some cases, multiple wear indicating circuits may be disposed on the brake pad 200. As show in FIG. 3, in accordance with an example embodiment, a first wear indicating circuit 231, a second wear indicating circuit 232, and a third wear indicating circuit 233 may be disposed on the brake pad 200. The first wear indicating circuit 231, the second wear indicating circuit 232, and the third wear indicating circuit 233 may be spaced apart (evenly or unevenly) to define clear wear thresholds at respective different known depths. For example, the first wear indicating circuit 231 may be disposed at 40% of the thickness of the brake lining 220, the second wear indicating circuit 232 may be disposed at 60% of the thickness of the brake lining 220, and the third wear indicating circuit 233 may be disposed at 80% of the thickness of the brake lining 220.

The multiple wear indicating circuits may not have to be evenly spaced apart on the brake lining 220. The multiple wear indicating circuits may be disposed at important wear thresholds or brake lining statuses for performance of the brake system 100. For example, the wear thresholds may be representative of different time frames or estimated remaining durability of the brake pad 200. For example, the first wear indicating circuit 231 may be disposed at a location to indicate three months of expected performance remaining, the second wear indicating circuit 232 may be disposed at a location to indicate one month of expected performance remaining, and the third wear indicating circuit 233 may be disposed at a location to indicate the limit of expected performance.

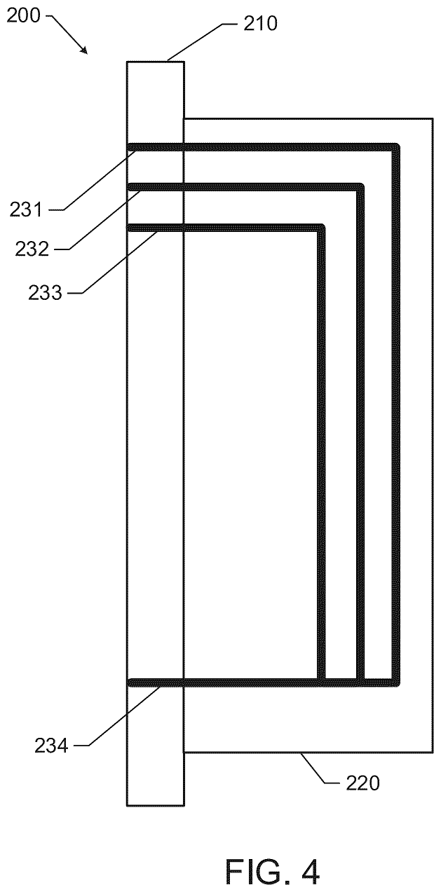

At one end of the wear indicating circuit 230, a ground connection may be located to provide a path for electricity to complete a circuit with respect to a power source. The ground connection may be disposed at either end on the wear indicating circuit 230. In some cases, if there are multiple wear indicating circuits, the multiple wear indicating circuits may share a ground connection. For example, as shown in FIG. 4, the first wear indicating circuit 231, the second wear indicating circuit 232, and the third wear indicating circuit 233 may share a common ground connection 234.

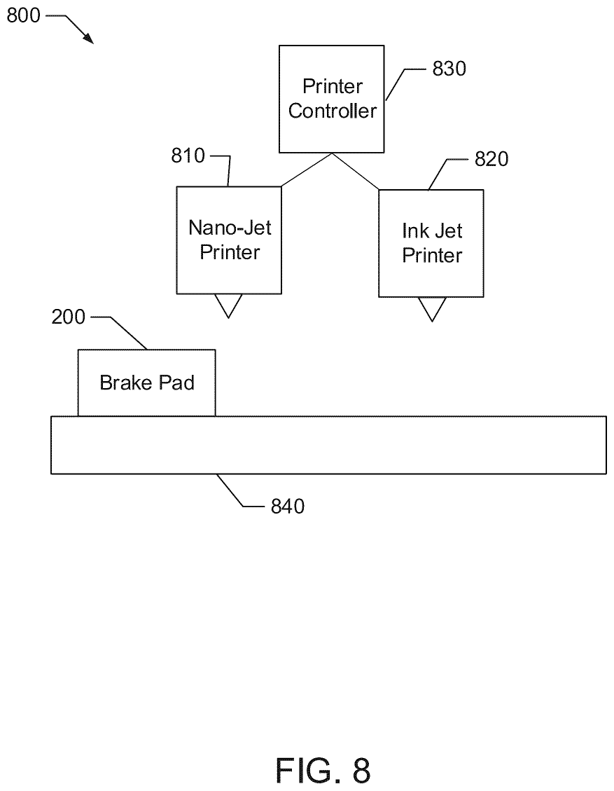

The wear indicating circuit 230 may be added to the brake pad 200 via conductive ink printing. In some cases, as shown in FIG. 8, conductive ink printing may be performed via a printing system 800. The printing system 800 may use an ink jet printer 820 to apply very precise circuits to a variety of objects, including fabrics and rigid objects. The conductive ink may be a liquid-based ink. With conductive ink printing, a computer-aided design (CAD) representation of circuitry or electronics may be directly incorporated during or after the primary manufacturing or assembly process of the brake pad 200 or brake system 100 without losing specificity. Conductive ink printing may include conductive inks composed with conductive metal fillers and polymer resins. The conductive metal fillers may provide desired electrical and thermal properties. For example, the conductive metal filler may be silver, as the conductive ink needs to be easily liquefied at relatively low temperatures (i.e. 500° F. or less), while maintaining its conductivity through the printing process and application. In some cases, the temperature threshold may be higher (i.e. 2000° F. or less) depending on the application. The polymer resins may provide mechanical strength and flexibility in application of the conductive ink printing. For example, silver nitrate may be a commonly used ink for conductive ink printing. Forming the wear indicating circuit 230 via conductive ink printing may allow for increased flexibility of the brake pad 200 and brake system 100. Additionally, the conductive ink printing may provide increased ease of integration of the wear indicating circuit 230. Conductive ink printing may also be conductive ink painting.

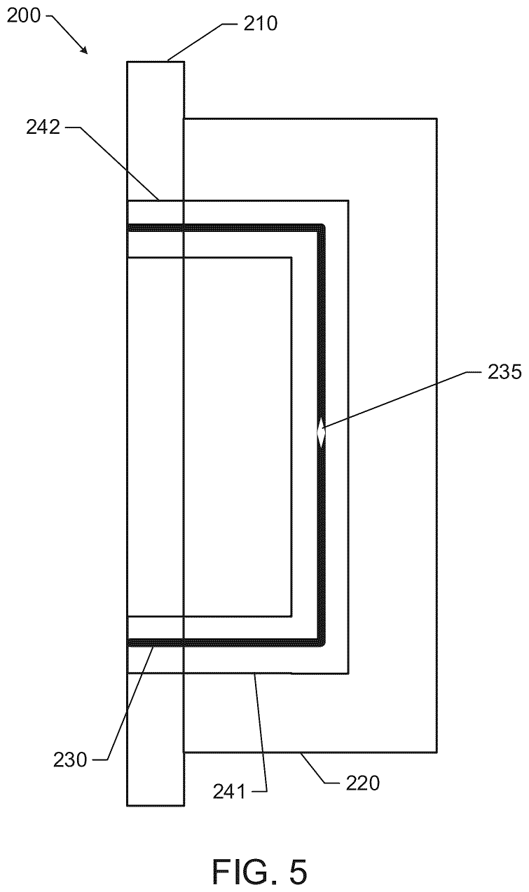

In an example embodiment, a thermocouple 235 (see FIG. 5) may be integrated and/or embedded within the wear indicating circuit 230. The thermocouple 235 may measure temperature of the brake pad 200 and/or the brake system 100. In some cases, the thermocouple 235 may consist of two wires integrated within the wear indicating circuit 230, and the thermocouple 235 may use a temperature gradient between the two wires to generate a proportional voltage. The proportional voltage may then be used to determine the temperature at the thermocouple 235. Conductive ink printing may ease the integration of the thermocouple 235 within the wear indicating circuit 230.

In some cases, the thermocouple 235 may provide a first set of data indicative of temperature at the brake pad 200. The first set of data may be used by a controller or control module of the vehicle 110 to help indicate brake fade. Especially in a brake system 100 that utilizes an electronic brake booster (EBB), brake fade may be difficult to detect. The controller or control module of the vehicle 110 may use the brake pad temperature from the first set of data to monitor or even adjust the brake system 100. Upon detection of brake fade, an indication may be delivered to the operator of the vehicle 110 and/or a parameter of the vehicle 110 may be adjusted.

In an example embodiment, the controller or control module of the vehicle 110 may include one or more controllers or control modules. The controller may include processing circuitry that includes a processor and memory. The processing circuitry may be configured to provide electronic control of the inputs to one or more functional units of the brake system 100 and to process data received at or generated by the one or more functional units of the vehicle control system. Thus, the processing circuitry may be configured to perform data processing, control function execution and/or other processing and management services according to an example embodiment. In some embodiments, the processing circuitry may be embodied as a semiconductor chip or chip set. In other words, the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

Adjustment of the brake system 100 may occur via the results of an algorithm that utilizes the first set of data, as well as potentially a second set of data received from other vehicle sensors. The algorithm may monitor the brake pad 200 and the brake temperature to adjust the brake system 100 depending on the brake temperature and the determined or detected use of the vehicle 110. For example, if the vehicle 110 is towing a load, the algorithm may monitor the brake temperature and adjust a parameter of the brake system 100 differently than if the vehicle was not towing a load.

The wear indicating circuit 230 may include additional sensors. For example, the thermocouple 235 may be part of a sensor suite embedded and/or integrated within the wear indicating circuit 230. Additional sensors of the sensor suite may include, but are not limited to, position sensors, force sensors, and speed sensors.

In some cases, the wear indicating circuit 230 may be integrated on top of or within a first insulating layer 241 applied to the brake pad 200. The first insulating layer 241 may be a ceramic, thermoplastic, or other material that provides electrical insulation for the wear indicating circuit 230. In an example embodiment, the brake pad 200 may have a second insulating layer 242. The first insulating layer 241 may be disposed on the brake lining 220 and the second insulating layer 242 may be disposed on the backing plate 210. The second insulating layer 242 may be a ceramic, thermoplastic, or other material that provides electrical insulation for the wear indicating circuit 230. The first insulating layer 241 and the second insulating layer 242 may be formed of the same material.

The wear indicating circuit 230, the first insulating layer 241, and the second insulating layer 242 may all be applied after the initial construction of the brake pad 200. For example, the wear indicating circuit 230, the first insulating layer 241, and the second insulating layer 242 may be added onto a completed brake pad via additive manufacturing. The first insulating layer 241 and the second insulating layer 242 may be applied via the printer system 800. The first insulating layer 241 and the second insulating layer 242 may be applied via a nano-jet printer 810 of the printer system 800, while the wear indicating circuit 230 may be applied via the ink jet printer 820 of the printer system 800. In some cases, the nano-jet printer 810 and the ink jet printer 820 may be individual pieces of a larger, single printer, or alternatively as a plurality of separate printers. The nano-jet printer 810 and the ink jet printer 820 may also be operably coupled to and operated via a printer controller 830. In an example embodiment, the nano-jet printer 810 may add the first insulating layer 241 and/or the second insulating layer 242 prior to the ink jet printer 820 adding the wear indicating circuit 230. In some cases, the moving apparatus 840 may move the brake pad 200 from the nano-jet printer 810 to the ink jet printer 820 and vice versa. The moving apparatus 840 may be a conveyer system or other device/system that may move the brake pad 200 throughout its production process.

The wear indicating circuit 230, the first insulating layer 241, and the second insulating layer 242 may be applied directly on top of a surface of the brake pad 200. Directly on top of a surface of the brake pad 200 may be externally to the brake pad 200 or directly on an external surface of the brake pad 200. The surface of the brake pad may be an edge of the brake pad that is not a primary surface engaging with the brake caliper 180 and the brake rotor 170.

Rather the surface of the brake pad 200 where the wear indicating circuit 230, the first insulating layer 241, and the second insulating layer 242 are applied may be a surface that includes both a portion of the brake lining 220 and the backing plate 210. Applying the wear indicating circuit 230 directly on the surface of the brake pad 200 may not require any physical alteration, modification, or adjustment of the brake pad 200 (i.e. no notch or slot added to integrate wear indicating circuit 230).

In some cases, the backing plate 210 may be skipped during the application of the wear indicating circuit 230 and the insulating layers. In this regards, the wear indicating circuit 230 and the insulating layers may only be applied to the brake lining 220. The backing plate 210 may be skipped to limit any interference or additional assembly time. Overall, the application of the wear indicating circuit 230, the first insulating layer 241, and the second insulating layer 242 may be designed to not require any modification of the backing plate 210 or the brake lining 220.

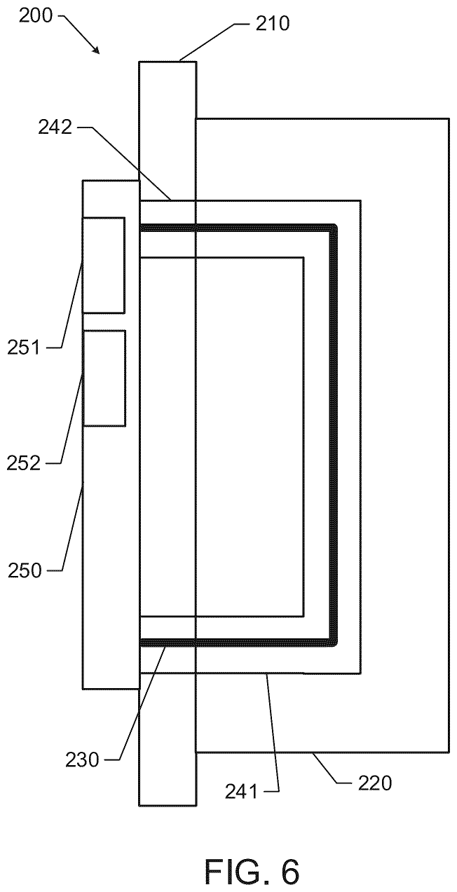

The wear indicating circuit 230 may be operably coupled to external systems 250. The external systems 250 may include other vehicle sensors/circuits, power sources, communication devices, and controllers/control modules. For example, as seen in FIG. 6, the external systems 250 includes a first control module 251 and the power source 252. The first control module 251 may be a main control module for the vehicle 110 or a brake system control module. In some cases, the first control module 251 may receive the first set of data from the thermocouple 235. The power source 252 may be brake system specific power source, the battery of the vehicle 110, or any other power source of the vehicle 110. The wear indicating circuit 230 may be directly connected to the external systems 250 via an electrical connector 260. The electrical connector 260 may be a plug or other connector that directly engages with the external systems 250 (i.e. first control module 251 and power source 252). In some cases, the wear indicating circuit 230 may have multiple instances of the electrical connector 250. In some cases, the structure of backing plate 210 may have an aperture, opening, or slot, and the wear indicating circuit 230 and/or the insulating layers may utilize the structure of the backing plate 210 for convenience during assembly of the brake system 100.

The other vehicle sensors may include wheel assembly sensors/circuits and suspension sensors/circuits. For example, the wear indicating circuit 230 may be operably coupled to a tire pressure monitoring circuit, and the wear indicating circuit 230 may share features of the tire pressure monitoring circuit, including but not limited to communication systems and power sources. The wear indicating circuit 230 may share power sources, communication systems/devices, and controllers with other vehicle components and subsystems.

In some cases, the wear indicating circuit 230 may be powered by the power source 252. The power source 252 may by operably coupled to the wear indicating circuit 230 by a wired connection, and the power source 252 may be one or more onboard power sources of the vehicle 110. Particularly, if the wear indicating circuit 230 is not operably coupled to other sensors or systems, the wear indicating circuit 230 may be powered by a very small electrical source. Only a small electrical potential may be needed to enable detection of a closed circuit (or detection of an opened circuit when the circuit is broken). The one or more onboard power sources of the vehicle 110 may be a primary battery or other battery of the vehicle 110. In an example embodiment, the one or more onboard power sources may be primary power sources for other vehicle components, including but not limited to a control module, vehicle sensor suites, and other powered suspension assembly/vehicle components. In some cases, the one or more onboard power sources may be integrated within the brake system 100. For example, the brake system 100 may include its own battery or power source 252.

In some cases, the power source 252 may include a piezoelectric element. The piezoelectric element may utilize movement or displacement of the brake system 100 and/or the vehicle 110 and convert the movement or displacement to electrical energy. In an example embodiment, the movement or displacement of the brake system 100 may be a compression, relaxation, and/or displacement of the brake pad 200 and may be converted into electrical power via the piezoelectric element, and the power may therefore not necessarily be continuously provided, but instead may be provided discretely or responsive to certain events. Detection of wear may then also be provided discontinuously or discretely when power is provided or in response to the certain events.

In some cases, the power source 252 may include a thermoelectric element. The thermoelectric element may utilize heat created via brake system 100 and convert the heat to electrical energy. In an example embodiment, the movement or displacement of the brake pad 200 with the brake rotor 170 may create heat, and the heat created may be converted into electrical power via the thermoelectric element. In some cases, the power source 252 may include a radio frequency (RF) power element. The RF power element may be a wireless power transfer element that picks up low-level radio frequency waves from a source and converts the wave's energy to electrical power. The wear indicating circuit 230 may therefore only require discontinuous power and/or a low power level, as noted above. For example, the wear indicating circuit 230 may only receive power periodically when wear level of the brake pad 200 is desired.

The construction and materials of the wear indicating circuit 230, the first insulating layer 241, and the second insulating layer 242 may be dependent and variable based on the specifications of the brake pad 200. For example, the materials of the backing plate 210 and/or the brake lining 220 may have result in a change of material or application process of the wear indicating circuit 230, the first insulating layer 241, and the second insulating layer 242.

A brake pad for a brake system of a vehicle may therefore be provided. The brake pad may include a brake lining configured to engage with a brake rotor operably coupled to a wheel of the vehicle to apply friction to slow the vehicle, a backing plate to provide support to the brake lining, and a wear indicating circuit operably coupled to the brake lining to detect brake lining wear. The wear indicating circuit may be externally printed on or within the brake pad via conductive ink.

The brake pad for a brake system for a vehicle of some embodiments may include additional features, modifications, augmentations and/or the like to achieve further objectives or enhance performance of the suspension assembly. The additional features, modifications, augmentations and/or the like may be added in any combination with each other. Below is a list of various additional features, modifications, and augmentations that can each be added individually or in any combination with each other. For example, a thermocouple may be integrated into the wear indicating circuit. In some cases, the thermocouple may provide a first set of data indicative of a temperature of the brake pad, and the first set of data may be transferred to a control module of the vehicle. The control module may adjust a parameter of the vehicle based on the first set of data. In an example embodiment, the thermocouple may be part of a sensor suite integrated into the wear indicating circuit. In some cases, the wear indicating circuit may be printed on or within an insulating layer. In an example embodiment, the insulating layer may be a ceramic, and the insulating layer may be printed via a nano-jet printer. The conductive ink may be printed via an ink jet printer. In some cases, the wear indicating circuit may be powered via discontinuous power. In an example embodiment, the wear indicating circuit may be one of a plurality of wear indicating circuits. In some cases, the plurality of wear indicating circuits maybe spaced at respective intervals by depth of the brake pad to indicate different corresponding wear thresholds. In an example embodiment, the wear detection circuit may be open responsive to a wear threshold of the brake pad being reached. In some cases, the wear detection circuit may share a power source with a separate vehicle component. In an example embodiment, the insulating layer may extend onto the brake lining and the backing plate, and brake lining may be a first type of the insulating layer. The backing plate may be a second type of the insulating layer.

A brake system for a vehicle of an example embodiment may therefore be provided. The brake system may include a brake rotor operably coupled to a wheel of the vehicle, and a brake pad to engage with the brake rotor to slow the vehicle. The brake pad may include a brake lining to engage with the brake rotor to apply friction to slow the vehicle, a backing plate to provide support to the brake lining, and a wear indicating circuit operably coupled to brake lining to detect brake lining wear. The wear indicating circuit may be externally printed on the brake pad via conductive ink.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to difficulties are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A brake pad for a brake system of a vehicle, the brake pad comprising:
a brake lining configured to engage with a brake rotor operably coupled to a wheel of the vehicle to apply friction to slow the vehicle;
a backing plate to provide support to the brake lining; and
a wear indicating circuit operably coupled to the brake lining to detect brake lining wear,
wherein the wear indicating circuit is externally printed on the brake pad via conductive ink.

2. The brake pad of claim 1, wherein a thermocouple is integrated into the wear indicating circuit.

3. The brake pad of claim 2, wherein the thermocouple provides a first set of data indicative of a temperature of the brake pad,
wherein the first set of data is transferred to a control module of the vehicle, and
wherein the control module adjusts a parameter of the vehicle based on the first set of data.

4. The brake pad of claim 2, wherein the thermocouple is part of a sensor suite integrated into the wear indicating circuit.

5. The brake pad of claim 1, wherein the wear indicating circuit is printed on or within an insulating layer.

6. The brake pad of claim 5, wherein the insulating layer is a ceramic,
wherein the insulating layer is printed via a nano-jet printer, and
wherein the conductive ink is printed via an ink jet printer.

7. The brake pad of claim 5, wherein the insulating layer extends onto the brake lining and the backing plate, and
wherein the brake lining has a first type of the insulating layer, and the backing plate has a second type of the insulating layer.

8. The brake pad of claim 1, wherein the wear indicating circuit is powered via discontinuous power.

9. The brake pad of claim 1, wherein the wear indicating circuit is one of a plurality of wear indicating circuits.

10. The brake pad of claim 9, wherein the plurality of wear indicating circuits are spaced at respective intervals by depth of the brake pad to indicate different corresponding wear thresholds.

11. The brake pad of claim 1, wherein the wear detection circuit is open responsive to a wear threshold of the brake pad being reached.

12. The brake pad of claim 1, wherein the wear detection circuit shares a power source with a separate vehicle component.

13. A brake system for a vehicle, the brake system comprising:
a brake rotor operably coupled to a wheel of the vehicle; and
a brake pad to engage with the brake rotor to slow the vehicle, the brake pad further comprising:
a brake lining configured to engage with the brake rotor to apply friction to slow the vehicle;
a backing plate to provide support to the brake lining; and
a wear indicating circuit operably coupled to the brake lining to detect brake lining wear,
wherein the wear indicating circuit is externally printed on the brake pad via conductive ink.

14. The brake system of claim 13, wherein a thermocouple is integrated into the wear indicating circuit.

15. The brake system of claim 14, wherein the thermocouple provides a first set of data indicative of a temperature of the brake pad,
wherein the first set of data is transferred to a control module of the vehicle, and
wherein the control module adjusts a parameter of the vehicle based on the first set of data.

16. The brake system of claim 14, wherein the thermocouple is part of a sensor suite integrated into the wear indicating circuit.

17. The brake system of claim 13, wherein the wear indicating circuit is printed on or within an insulating layer.

18. The brake system of claim 17, wherein the insulating layer is a ceramic,
wherein the insulating layer is printed via a nano-jet printer, and
wherein the conductive ink is printed via an ink jet printer.

19. The brake system of claim 13, wherein the wear indicating circuit is one of a plurality of wear indicating circuits.

20. The brake system of claim 13, wherein the wear detection circuit is open responsive to a wear threshold of the brake pad being reached.
